(19) United States
(12) Patent Application Publication
(10) Pub. No.: US 2017/0353502 A1
(43) Pub. Date: Dec. 7, 2017

(54) DIGITMAP CONFIGURATION METHOD, SIP SERVER, SIP TERMINAL AND DIGITMAP CONFIGURATION SYSTEM

(71) Applicant: ZTE CORPORATION, Shenzhen City (CN)

(72) Inventors: Wenhua ZHU, Shenzhen City (CN); Hongbin JIANG, Shenzhen City (CN); Hao CHEN, Shenzhen City (CN); Yongcheng DONG, Shenzhen City (CN); Jianlong ZHANG, Shenzhen City (CN)

(73) Assignee: ZTE CORPORATION, Shenzhen City (CN)

(21) Appl. No.: 15/507,048

(22) PCT Filed: Oct. 20, 2014
(86) PCT No.: PCT/CN2014/088906

§ 371 Date: Jul. 6, 2017

(30) Foreign Application Priority Data
Aug. 28, 2014 (CN) 201410432361.3

(51) Int. Cl. H04L 29/06; H04L 12/24; H04M 1/253

(52) U.S. Cl. CPC H04L 65/1006; H04L 41/0803; H04M 2203/15; H04L 65/105; H04Q 2213/13353; H04M 1/2535

(57) ABSTRACT

A digitmap configuration method, device and system are described. The method includes: detecting, by a session initiation protocol (SIP) server, a configuration condition; and when the configuration condition is satisfied, issuing, by the SIP server, a latest digitmap using a MESSAGE to an SIP terminal. The method, device and system realize the flexible configuration conducted on a digitmap of an SIP terminal, and solve the problem that the related SIP terminal digitmap configuration manner lacks flexibility.

### CROSS-REFERENCE TO RELATED APPLICATION

This application is the U.S. national phase of PCT Application No. PCT/CN2014/088906 filed Oct. 20, 2014, which claims priority to Chinese Application No. 201410432361.3 filed Aug. 28, 2014, the disclosures of which are incorporated in their entirety by reference herein.

### TECHNICAL FIELD

The present disclosure relates to the field of digitmap configuration technology in Next Generation Network NGN, and in particular to a digitmap configuration method, apparatus and system in the NGN network.

### BACKGROUND

A digitmap is a dialing plan stored in a voice terminal or a gateway device and used for detecting and reporting dialing events, and the digitmap defines one or a plurality of rules of permitting a user to dial numbers. At present, for terminals using different voice call control protocols, digitmap acquisition ways of the terminals are also different. For the MGCP/H.248 protocol, generally the digitmap is sent to the terminal by a SoftSwitch through an MGCP/H.248 message. For a Session Initiation Protocol SIP, since the protocol itself does not define related contents and sending modes of the digitmap, two ways are usually adopted at present. One is to preconfigure the digitmap on the terminal, and the other one is to configure the digitmap to the terminal by a network management server through protocols such as TR069 or the like.

For a SIP terminal to acquire the digitmap, either the preconfiguration way or the network management configuration way lacks enough flexibility. Taking the network management configuration way as an example, since a network management device is an independent network element uncorrelated with the voice call control, the network management device cannot flexibly switch the digitmap according to service attributes and service flows of the user like a SIP server.

### SUMMARY

Embodiments of the present disclosure provide a digitmap configuration method, apparatus and system, which solves the problem that the related SIP terminal digitmap configuration ways lack flexibility.

To solve the above technical problem, the following technical scheme is adopted.

A digitmap configuration method includes the following steps.

A session initiation protocol SIP sever detects a configuration condition.

When the configuration condition is satisfied, the SIP server sends a latest digitmap to a SIP terminal through a MESSAGE.

In an exemplary embodiment, the configuration condition includes any one or more of the following conditions:

the SIP terminal is registered to the SIP server successfully;

a service attribute of an service on the SIP server changes, and a digitmap of a user is required to be modified; and

different digitmaps are required to be used at different stages of a voice service.

In an exemplary embodiment, the SIP server is a network element implementing call control.

A digitmap configuration method includes the following steps.

A SIP terminal receives a MESSAGE sent by a SIP server. Herein, the MESSAGE carries a latest digitmap.

The SIP terminal updates a digitmap according to the MESSAGE sent by the SIP server.

In an exemplary embodiment, when the latest digitmap is saved, if there has been an original digitmap, the SIP terminal covers the original digitmap with the latest digitmap.

A SIP server includes a detection module and a digitmap sending module.

The detection module is arranged to detect a configuration condition.

The digitmap sending module is arranged to, when the configuration condition is satisfied, send a latest digitmap to a SIP terminal through a MESSAGE.

A SIP terminal includes a configuration receiving module and a configuration saving module.

The configuration receiving module is arranged to receive a MESSAGE sent by a SIP server. Herein, the MESSAGE carries a latest digitmap.

The configuration saving module is arranged to update a digitmap according to the MESSAGE sent by the SIP server.

In an exemplary embodiment, the configuration saving module is further arranged to, when the latest digitmap is saved, if there has been an original digitmap, cover the original digitmap with the latest digitmap.

A digitmap configuration system includes a SIP server and a terminal registered to the SIP server.

The SIP server is arranged to, detect a configuration condition, and when the configuration condition is satisfied, send a latest digitmap to the SIP terminal through a MESSAGE.

The SIP terminal is arranged to receive the MESSAGE sent by the SIP server, herein, the MESSAGE carries the latest digitmap; and update a digitmap according to the MESSAGE sent by the SIP server.

In an exemplary embodiment, the configuration condition includes any one or more of the following conditions:

the SIP terminal is registered to the SIP server;

a service attribute of a service on the SIP server changes, and a digitmap of a user is required to be modified; and

different digitmaps are required to be used at different stages of a voice service.

A computer program, including a program instruction is provided. Herein, when the program instruction is executed by a session initiation protocol SIP sever, the session initiation protocol SIP sever can execute the corresponding digitmap configuration method.

A carrier carrying the computer program is provided.

A computer program including a program instruction is provided. Herein, when the program instruction is executed by a session initiation protocol SIP terminal, the session initiation protocol SIP terminal can execute the corresponding digitmap configuration method.

A carrier carrying the computer program is provided.

With the digitmap configuration method, apparatus and system of the above technical scheme, a SIP server detects a configuration condition, and when the configuration condition is satisfied, the SIP server sends a latest digitmap to a SIP terminal through a MESSAGE; the SIP terminal receives the MESSAGE sent by the SIP server, and updates a digitmap according to the MESSAGE sent by the SIP server. Therefore, the flexible digitmap configuration on the SIP terminal is implemented, and the problem that the related SIP terminal digitmap configuration ways lack flexibility is solved.

### BRIEF DESCRIPTION OF DRAWINGS

FIG. 1 is a flow chart of a digitmap configuration method provided in embodiment 1 of the present disclosure.

FIG. 2 is a flow chart of a SIP terminal acquiring a digitmap from a network management server in embodiment 2 of the present disclosure.

FIG. 3 is a flow chart of a SIP terminal acquiring a digitmap from a SIP server through a MESSAGE in embodiment 2 of the present disclosure.

FIG. 4 is a schematic diagram of a structure of a digitmap configuration apparatus provided in embodiment 3 of the present disclosure.

FIG. 5 is a schematic diagram of a structure of another digitmap configuration apparatus provided in embodiment 3 of the present disclosure.

### DETAILED DESCRIPTION

For a SIP terminal to acquire the digitmap, either the preconfiguration way or the network management configuration way lacks enough flexibility. Taking the network management configuration way as an example, since a network management device is an independent network element uncorrelated with the voice call control, the network management device cannot flexibly switch the digitmap according to service attributes and service flows of the user like a SIP server.

To solve the above problem, embodiments of the present disclosure provide a digitmap configuration method, apparatus and system. According to embodiments of the present disclosure, a SIP server sends a digitmap to a SIP terminal through a MESSAGE, and the MESSAGE carrying the digitmap is required to indicate that the MESSAGE carries the “digitmap”, so that the SIP terminal can identify the message. The embodiments of the present disclosure will be described in detail in combination with the accompanying drawings below. It should be noted that the embodiments in the present disclosure and the characteristics in the embodiments may be arbitrarily combined with each other in the case of no conflict.

Firstly embodiment 1 of the present disclosure will be described in combination with the accompanying drawing.

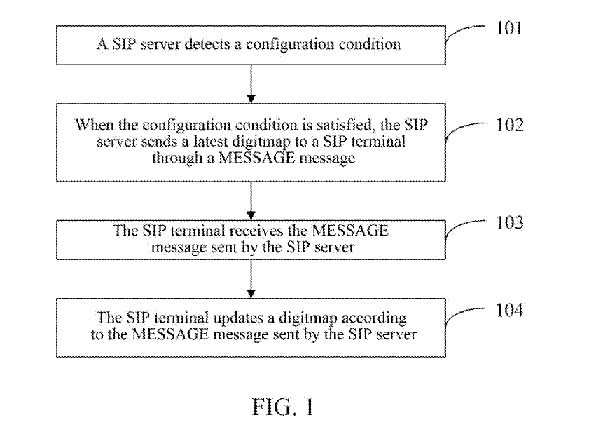

An embodiment of the present disclosure provides a digitmap configuration method. A flow of configuring a digitmap of a SIP terminal with the method is as shown in FIG. 1, and the following steps 101-104 are included.

In step 101, a SIP server detects a configuration condition.

In the embodiment of the present disclosure, the configuration condition includes any one or more of the following conditions:

1. The SIP terminal is registered to the SIP server successfully.

2. When a service attribute of a service on the SIP server changes, a digitmap of a user is required to be modified.

3. different digitmaps are required to be used at different stages of a voice service.

In step 102, when the configuration condition is satisfied, the SIP server sends a latest digitmap to a SIP terminal through a MESSAGE.

In the step, when the SIP terminal is registered to the SIP server successfully, or when a service attribute of a user on the SIP server changes and a digitmap of the user is required to be modified, or when different digitmaps are required to be used at different stages of a voice service, the SIP server may send the latest digitmap to the SIP terminal in real time through the MESSAGE.

In step 103, the SIP terminal receives the MESSAGE sent by the SIP server, herein, the MESSAGE carries the latest digitmap.

In step 104, the SIP terminal updates a digitmap according to the MESSAGE sent by the SIP server.

In the step, the SIP terminal is required to receive, identify and save the digitmap in the MESSAGE and applies the digitmap to a later call process of the user. An original digitmap should be covered when the SIP terminal receives a new digitmap.

In the NGN network, a softswitch as the SIP server is a network element implementing call control. Compared with a network management sever, the scheme that the softswitch sends the digitmap to the SIP terminal is more flexible and easy to manage, and the softswitch may send different digitmaps to various users according to different service authorities and even different stages of a voice service flow.

Embodiment 2 of the present disclosure will be described in combination with the accompanying drawings below.

An embodiment of the present disclosure provides a digitmap configuration method. a flow of a SIP terminal acquiring a digitmap from a network management server and a flow of the SIP terminal acquiring a digitmap from a SIP server through a MESSAGE will be respectively described in combination with the accompanying drawings below.

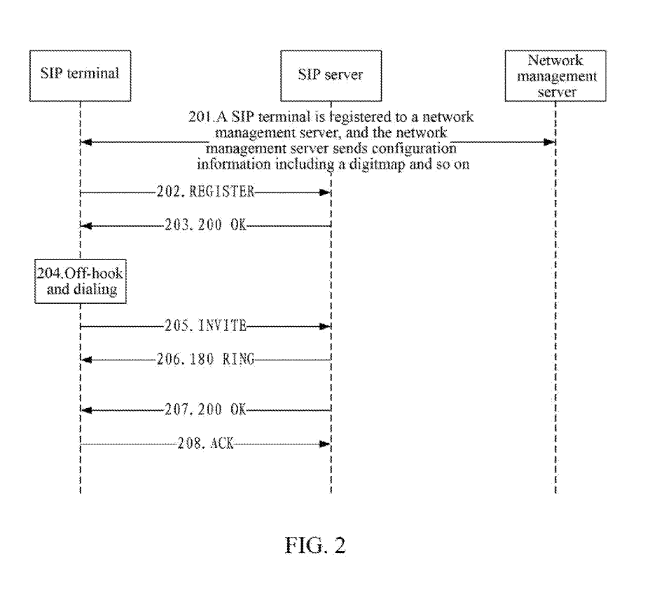

FIG. 2 is a flow of the SIP terminal acquiring a digitmap from a network management server, and the following steps 201-205 are included.

In step 201, a SIP terminal makes a registration to a network management server, and the network management server sends configuration information including a digitmap to the SIP terminal after the registration is successful, and the SIP terminal saves digitmap information.

In step 202 to step 203, the SIP terminal initiates a SIP registration to a SIP server and receives a response normally, and the registration is successful.

In step 204, a user takes off-hook and performs number receiving according to the digitmap rule saved in the step 1.

In step 205 to step 208, the number receiving is completed, and the SIP terminal sends an INVITE message and initiates and establishes a call normally.

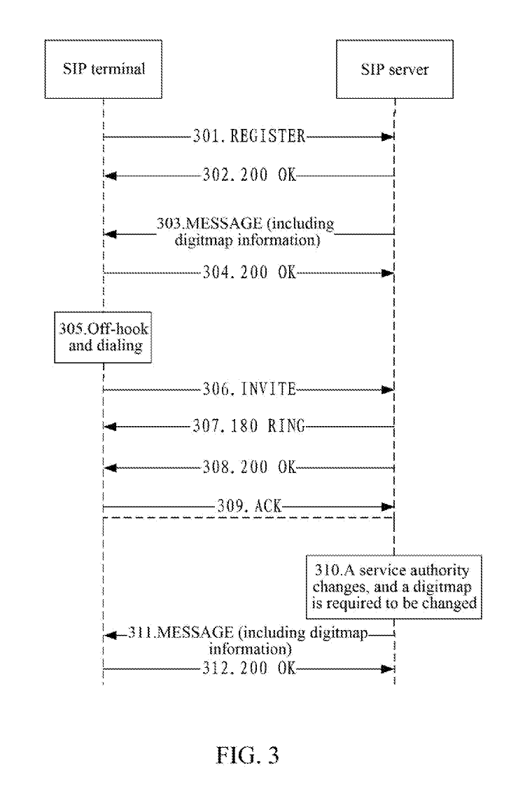

A flow of a SIP terminal acquiring a digitmap during a registration is as shown in FIG. 3, and the following steps 301-309 are included.

In step 301 to step 302, a SIP terminal initiates a SIP registration to a SIP server and receives a response normally, and the registration is successful.

In step 303 to step 304, the SIP server sends a digitmap corresponding to the user to the SIP terminal through a MESSAGE, and the SIP terminal saves the digitmap and makes a normal response to the SIP server.

In step 305, the user takes off-hook and performs number receiving according to the digitmap rule saved in the step 3.

In step 306 to step 309, the number receiving is completed, and the SIP terminal sends an INVITE message and initiates and establishes a call normally.

A flow of acquiring a digitmap when a user service authority changes includes the following steps 310-312 as follows.

In step 310, a service authority of a terminal user on a SIP server changes, and then a digitmap corresponding to the user is required to be changed.

In step 311 to step 312, the SIP server sends a latest digitmap to a SIP terminal through a MESSAGE, and the SIP terminal saves the latest digitmap and makes a response normally.

Embodiment 3 of the present disclosure will be described in combination with the accompanying drawings below.

An embodiment of the present disclosure provides a SIP server. A structure of the SIP server is as shown in FIG. 4, which includes a detection module 401and a digitmap sending module 402.

The detection module 401 is arranged to detect a configuration condition.

The digitmap sending module 402 is arranged to, when the configuration condition is satisfied, send a latest digitmap to a SIP terminal through a MESSAGE.

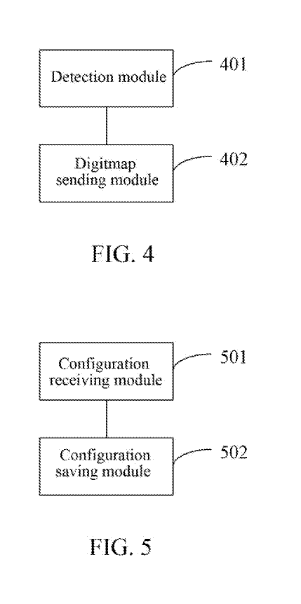

An embodiment of the present disclosure also provides a SIP terminal. A structure of the SIP terminal is as shown in FIG. 5, which includes a configuration receiving module 501 and a configuration saving module 502.

The configuration receiving module 501 is arranged to receive a MESSAGE sent by a SIP server. Herein, the MESSAGE carries a latest digitmap.

The configuration saving module 502 is arranged to update a digitmap according to the MESSAGE sent by the SIP server.

In an exemplary embodiment, the configuration saving module 502 is further arranged to, when the latest digitmap is saved, if there has been an original digitmap, cover the original digitmap with the latest digitmap.

An embodiment of the present disclosure also provides a digitmap configuration system, which includes a SIP server and a terminal registered to the SIP server.

The SIP server is arranged to detect a configuration condition, and when the configuration condition is satisfied, send a latest digitmap to a SIP terminal through a MESSAGE.

The SIP terminal is arranged to receive the MESSAGE sent by the SIP server, herein, the MESSAGE carries the latest digitmap; and update a digitmap according to the MESSAGE sent by the SIP server.

In an exemplary embodiment, the configuration condition includes any one or more of the following:

The SIP terminal is registered to the SIP server successfully.

A service attribute of a service on the SIP server changes, and a digitmap of a user is required to be modified.

Different digitmaps are required to be used at different stages of a voice service.

The embodiments of the present disclosure provide a digitmap configuration method, apparatus and system. According to the embodiments of the present disclosure, a SIP server detects a configuration condition, and when the configuration condition is satisfied, the SIP server sends a latest digitmap to a SIP terminal through a MESSAGE; the SIP terminal receives the MESSAGE sent by the SIP server, and updates a digitmap according to the MESSAGE sent by the SIP server, s to apply the latest digitmap to a later call process. Therefore, the flexible digitmap configuration on the SIP terminal is implemented, and the problem that the related SIP terminal digitmap configuration ways lack flexibility is solved.

The ordinary person skilled in the art can understand that all or part of steps of the above embodiments can be implemented by using a flow of computer program. The computer program may be stored in a computer readable memory medium. The computer program is executed on corresponding hardware platforms (such as a system, a device, an apparatus and a component, etc.), and when the computer program is executed, one of the steps or a combination of the steps of the method embodiments is comprised.

Alternatively, all or part of the steps of the above embodiments can also be implemented by using integrated circuits, these steps can be made into a plurality of integrated circuit modules respectively, or a plurality of modules or steps therein can be made into a single integrated circuit module to be implemented. Therefore, the present disclosure is not limited to any combination of hardware and software in a specific form.

Various apparatuses/functional modules/functional units in the above embodiments can be implemented by using a universal calculating device, and they can be concentrated on a single calculating device or distributed in a network consisting of a plurality of calculating devices.

If implemented in the form of a software function module and sold or used as an independent product, various apparatuses/functional modules/functional units in the above embodiments can be stored in a computer readable memory medium. The above-mentioned computer readable memory medium may be a read-only memory, a magnetic disk or an optical disk, etc.

Changes or substitutions which may occur easily to any skilled people familiar to the art within the technical scope disclosed by the present disclosure shall all be covered within the protection scope of the present disclosure. Therefore, the protection scope of the present disclosure should be subject to the protection scope described by the claims.

### INDUSTRIAL APPLICABILITY

The above technical scheme implements flexible digitmap configuration on the SIP terminal, and solves the problem that the related SIP terminal digitmap configuration ways lack flexibility. Therefore, the present disclosure has very strong industrial applicability.

1. A digitmap configuration method, comprising:
detecting, by a session initiation protocol, SIP, sever, a configuration condition; and
sending, by the SIP server, a latest digitmap to a SIP terminal through a MESSAGE when the configuration condition is satisfied.

2. The digitmap configuration method according to claim 1, wherein, the configuration condition comprises any one or more of the following conditions:
the SIP terminal is registered to the SIP server successfully;
a service attribute of an service on the SIP server changes, and a digitmap of a user is required to be modified; and
different digitmaps are required to be used at different stages of a voice service.

3. The digitmap configuration method according to claim 1, wherein, the SIP server is a network element implementing call control.

4. A digitmap configuration method, comprising:
receiving, by a SIP terminal, a MESSAGE sent by a SIP server, wherein, the MESSAGE carries a latest digitmap; and
updating, by the SIP terminal, a digitmap according to the MESSAGE sent by the SIP server.

5. The digitmap configuration method according to claim 4, wherein,
when the SIP terminal saves the latest digitmap, if there has been an original digitmap, the SIP terminal covers the original digitmap with the latest digitmap.

6. A SIP server, comprising a detection module and a digitmap sending module, wherein:
the detection module is arranged to detect a configuration condition; and
the digitmap sending module is arranged to, when the configuration condition is satisfied, send a latest digitmap to a SIP terminal through a MESSAGE.

7. A SIP terminal implementing the digitmap configuration method according to claim 4, comprising a configuration receiving module and a configuration saving module, wherein:
the configuration receiving module is arranged to receive a MESSAGE sent by a SIP server, wherein, the MESSAGE carries a latest digitmap; and
the configuration saving module is arranged to update a digitmap according to the MESSAGE sent by the SIP server.

8. The digitmap configuration apparatus according to claim 7, wherein,
the configuration saving module is further arranged to, when the latest digitmap is saved, if there has been an original digitmap, cover the original digitmap with the latest digitmap.

9. A digitmap configuration system, comprising a SIP server and a terminal according to claim 7, which is registered to the SIP server, wherein:
the SIP server is arranged to detect a configuration condition, and when the configuration condition is satisfied, send a latest digitmap to the SIP terminal through a MESSAGE; and
the SIP terminal is arranged to receive the MESSAGE sent by the SIP server, wherein the MESSAGE carries the latest digitmap; and update a digitmap according to the MESSAGE sent by the SIP server.

10. The digitmap configuration system according to claim 9, wherein, the configuration condition comprises any one or more of the following conditions:
the SIP terminal is registered to the SIP server successfully;
a service attribute of an service on the SIP server changes, and a digitmap of a user is required to be modified; and
different digitmaps are required to be used at different stages of a voice service.

11. A computer program, comprising a program instruction, wherein, when the program instruction is executed by a session initiation protocol, SIP, sever, the SIP sever can execute the digitmap configuration method according to claim 1.

12. A carrier carrying the computer program according to claim 11.

13. A computer program, comprising a program instruction, wherein, when the program instruction is executed by a SIP terminal, the SIP terminal can execute the digitmap configuration method according to claim 4.

14. A carrier carrying the computer program according to claim 13.

15. A computer program, comprising a program instruction, wherein, when the program instruction is executed by a session initiation protocol, SIP, sever, the SIP sever can execute the digitmap configuration method according to claim 2.

16. A carrier carrying the computer program according to claim 15.

17. A computer program, comprising a program instruction, wherein, when the program instruction is executed by a session initiation protocol, SIP, sever, the SIP sever can execute the digitmap configuration method according to claim 3.

18. A carrier carrying the computer program according to claim 17.

19. A computer program, comprising a program instruction, wherein, when the program instruction is executed by a SIP terminal, the SIP terminal can execute the digitmap configuration method according to claim 5.

20. A carrier carrying the computer program according to claim 19.
